(19) United States
(12) Patent Application Publication
(10) Pub. No.: US 2012/0155953 A1
(43) Pub. Date: Jun. 21, 2012

(54) SEAL RING STABILIZATION SYSTEM AND ASSOCIATED PIN JOINT ASSEMBLY

(75) Inventors: Roopam Khare, Aurora, IL (US); Simon S. Liang, Aurora, IL (US)

(73) Assignee: Caterpillar Inc., Peoria, IL (US)

(21) Appl. No.: 13/313,140

(22) Filed: Dec. 7, 2011

Related U.S. Application Data
(60) Provisional application No. 61/425,643, filed on Dec. 21, 2010.

(51) Int. Cl. F16J 15/16; F16C 11/04

(52) U.S. Cl. 403/161; 277/500

(57) ABSTRACT

A seal ring stabilization system disclosed herein includes first and second seal rings, each including a substantially planar surface and a substantially non-planar surface opposite the substantially planar surface. The substantially planar surface of the first seal ring and the substantially planar surface of the second seal ring engage one another. The first seal ring includes a protrusion extending from the substantially planar surface of the first seal ring and away from the substantially non-planar surface of the first seal ring, while the second seal ring defines a recess extending from the substantially planar surface of the first seal ring and toward the substantially non-planar surface of the second seal ring. The recess of the second seal ring receives the protrusion of the first seal ring.

### RELATED APPLICATIONS

This application is based upon, claims priority to, and otherwise claims the benefit of U.S. Provisional Application No. 61/425,643 by Roopam Khare, et al., filed Dec. 21, 2010, the contents of which are expressly incorporated herein by reference.

### TECHNICAL FIELD

This invention generally relates to stabilizing the seal rings in a pin joint assembly for machinery and equipment.

### BACKGROUND

Pin joints are employed on many types of residential and industrial machinery and equipment, for instance to provide pivot points between adjoining components. Most pin joints include various assemblies and structures intended to help prevent premature breakage or wear, for instance components that define chambers for holding lubricant. However, radial and axial loads endured by pin joints can be extreme, causing high mechanical and thermal stress and strain of pin joint assemblies. Such stress and strain can not only cause component breakage and wear, it can cause leakage or release of lubricant, which in turn can lead to further component breakage and wear as well as environmental pollution. In fact, some machinery and equipment are even designed to regularly pump fresh lubricant into pin joints in order to replace continually leaking lubricant. As demands on pin joint assemblies increase in succeeding generations of machinery and equipment, more robust pin joint assembly designs are needed.

U.S. Pat. No. 7,309,186 to Oertley (“Oertley '186”), which, like the present application and invention, is assigned to Caterpillar Inc., discloses a pin cartridge for a pin joint. Specifically, Oertley '186 describes a pin cartridge assembly that includes a pin, a bushing, a collar at each end of the pin, and a sleeve bearing between each end of the bushing and the pin. Two-element seals known to those of ordinary skill in the art as “can and lip” seals help retain lubricant in the pin cartridge.

### SUMMARY

A seal ring stabilization system disclosed herein includes first and second seal rings, each including a substantially planar surface and a substantially non-planar surface opposite the substantially planar surface. The substantially planar surface of the first seal ring and the substantially planar surface of the second seal ring engage one another. The first seal ring includes a protrusion extending from the substantially planar surface of the first seal ring and away from the substantially non-planar surface of the first seal ring, while the second seal ring defines a recess extending from the substantially planar surface of the first seal ring and toward the substantially non-planar surface of the second seal ring. The recess of the second seal ring receives the protrusion of the first seal ring.

A pin joint assembly disclosed herein includes a pin having an end portion, a bushing coaxial with the pin and having an end portion proximal to the end portion of the pin, and a collar engaging the end portion of the pin and having inner and outer portions, the inner portion of the collar being proximal to the end portion of the bushing. The pin joint assembly further includes first and second seal rings, each including a substantially planar surface and a substantially non-planar surface opposite the substantially planar surface. The substantially planar surface of the first seal ring and the substantially planar surface of the second seal ring engage one another. The first seal ring includes a protrusion extending from the substantially planar surface of the first seal ring and away from the substantially non-planar surface of the first seal ring, while the second seal ring defines a recess extending from the substantially planar surface of the first seal ring and toward the substantially non-planar surface of the second seal ring. The recess of the second seal ring receives the protrusion of the first seal ring.

### BRIEF DESCRIPTION OF THE DRAWINGS

FIG. 1 is a fragmentary isometric view of a machine with a linkage having a pivot point, all shown in phantom, together with a pin joint assembly installed at the pivot point, the pin joint assembly and included seal ring stabilization system being in accord with an embodiment of the invention;

FIG. 2 is a cross-sectional view of the pin joint assembly shown in FIG. 1, taken through line 2-2 in FIG. 1;

FIG. 3 is a detail of FIG. 2 encompassed by arc 3 in FIG. 2;

FIG. 4 is a perspective view of a pair of mating seal rings according to an embodiment of the invention; and

FIG. 5 is a perspective view of another pair of mating seal rings according to another embodiment of the invention.

### DETAILED DESCRIPTION

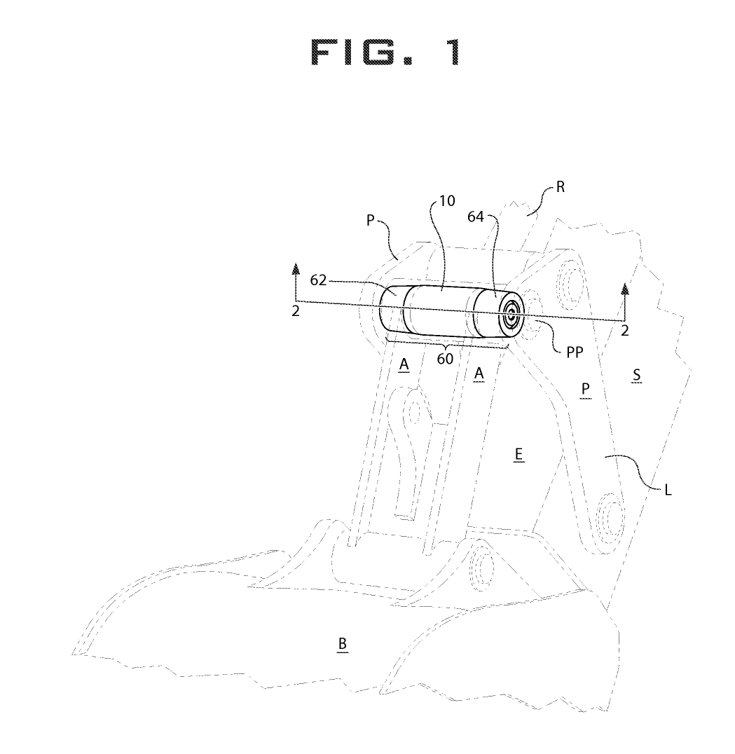

A pin joint assembly according to an embodiment of the invention is shown broadly in FIG. 1 at reference numeral 10. By way of example and not by way of limitation, the pin joint assembly 10 is shown installed on an excavator “E” at a pivot point “PP” of a linkage “L” between a stick “S” and a bucket “B”. More specifically, in the illustrated example the pin joint assembly 10 helps enable plates “P” coupled to the stick “S” to move in conjunction with arms “A” coupled to the bucket “B”. The overall linkage “L” enables movement of the bucket “B” by a rod “R” of a hydraulic cylinder (not shown) mounted on the stick “S”.

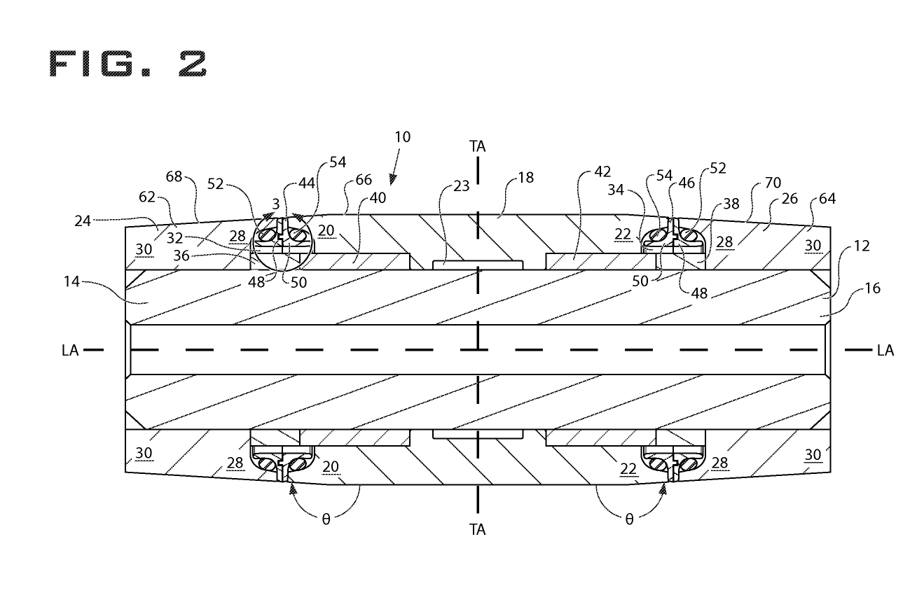

Turning now to FIG. 2, the pin joint assembly 10 is shown in cross-section. The pin joint assembly 10 includes a pin 12 with first and second end portions 14, 16 opposite one another and a bushing 18 with first and second end portions 20, 22 opposite one another, the first and second end portions 14, 16 of the pin 12 and the first and second end portions 20, 22 of the bushing 18 being proximal to one another, respectively. The pin 12 defines a longitudinal axis “LA” and the bushing 18 is coaxial with the pin 12 about the longitudinal axis “LA”. A transverse axis “TA” shown in FIG. 2 is substantially perpendicular to the longitudinal axis “LA”. The bushing 18 defines a substantially centrally disposed void 23 for receiving lubricant (not shown). The pin joint assembly 10 further includes first and second collars 24, 26 engaging the first and second end portions 14, 16 of the pin 12, respectively. The first and second collars 24, 26 each have an inner portion 28 and an outer portion 30. The inner portions 28 of the first and second collars 24, 26 are oriented in proximal relation to the first and second end portions 20, 22 of the bushing 18, respectively, and the outer portions 30 of the first and second collars 24, 26 are oriented in distal relation to the first and second end portions 20, 22 of the bushing 18, respectively.

The first end portion 20 of the bushing 18, the inner portion 28 of the first collar 24, and the pin 12 cooperate to define a substantially annular first channel 32 for receiving lubricant (not shown). Similarly, the second end portion 22 of the bushing, the inner portion 28 of the second collar 26, and the pin 12 cooperate to define a substantially annular second channel 34, also for receiving lubricant (not shown). First and second thrust rings 36, 38 that are coaxial with the pin 12 about the longitudinal axis “LA” reside in the first and second channels 32, 34, respectively. The thrust rings 36, 38 are oriented in spaced-apart relation relative to the bushing 18. First and second sleeve bearings 40, 42 that are coaxial with the pin 12 about the longitudinal axis “LA” engage the first and second end portions 20, 22 of the bushing 18, respectively, and also engage the pin 12. The first thrust ring 36 engages the pin 12 between the inner portion 28 of the first collar 24 and the first sleeve bearing 40, while the second thrust ring 38 engages the pin 12 between the inner portion 28 of the second collar 26 and the second sleeve bearing 42. The first and second thrust rings 36, 38 may also intermittently or continuously engage the first and second sleeve bearings 40, 42 during use of the pin joint assembly 10.

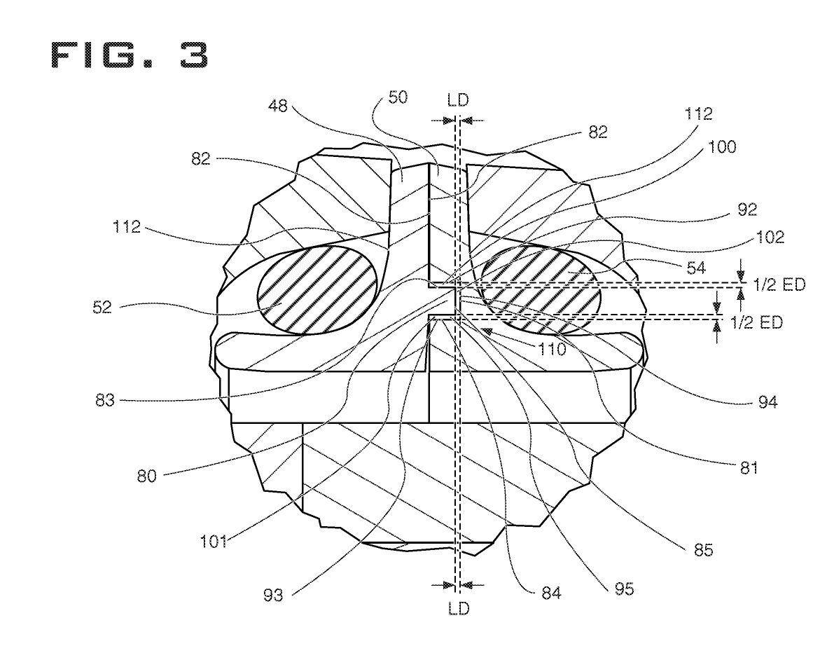

Looking now at FIG. 3, itself a detail from FIG. 2, the pin joint assembly 10 further includes first and second metal-to-metal face seals 44, 46, each having first and second seal rings 48, 50 and first and second gaskets 52, 54. The first and second seal rings 48, 50 in each of the seals 44, 46 abut one another. Further, in the first seal 44, the first gasket 52 engages and seals the first collar 24 with the first seal ring 48, and the second gasket 54 engages and seals the bushing 18 with the second seal ring 50. Similarly, in the second seal 46, the first gasket 52 engages and seals the second collar 26 with the first seal ring 48, and the second gasket 54 engages and seals the bushing 18 with the second seal ring 50.

Each of the seals 44, 46 includes a seal ring stabilization system 110. Specifically, the first seal ring 48 in each of the seals 44, 46 includes at least one projection or protrusion 80 while the second seal ring 50 in each of the seals 44, 46 defines at least one recess 81 for receiving the protrusion 80 of the corresponding first seal ring 48. The first and second seal rings 48, 50 each include major seal ring engagement surfaces 82 and a major gasket engagement surface 112. The major seal ring engagement surfaces 82 of each seal ring 48, 50 are substantially planar and, after assembly of the pin joint assembly 10, are substantially perpendicular to the longitudinal axis “LA” (FIG. 2). The major gasket engagement surface 112 of each seal ring 48, 50 is substantially non-planar and opposes the corresponding major seal ring engagement surfaces 82. The protrusion 80 extends from the major seal ring engagement surfaces 82 and away from the major gasket engagement surface 112 of each seal ring 48, 50, while the recess 81 extends from the major seal ring engagement surfaces 82 and toward the major gasket engagement surface 112 of each seal ring 48, 50.

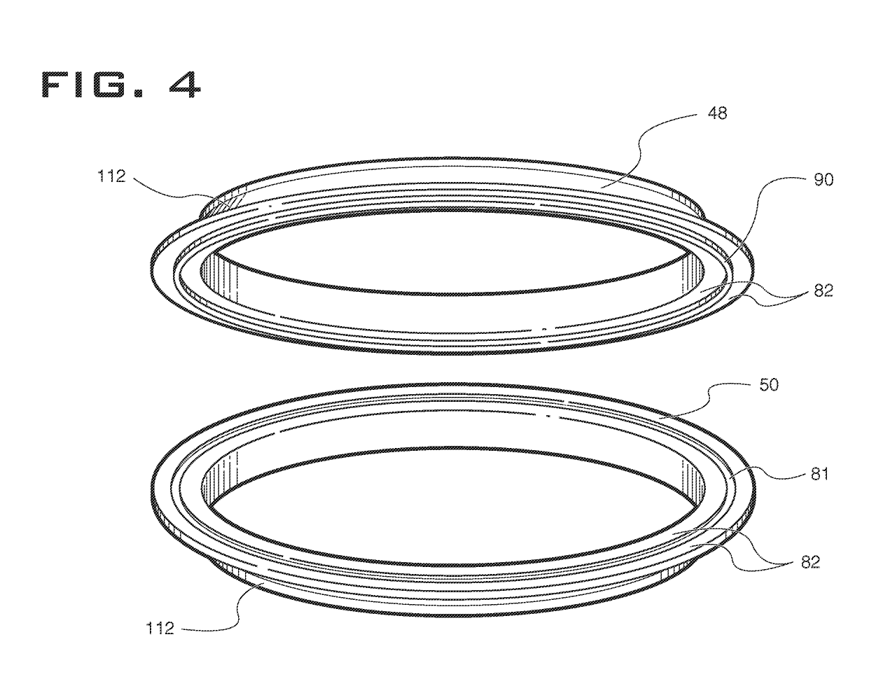

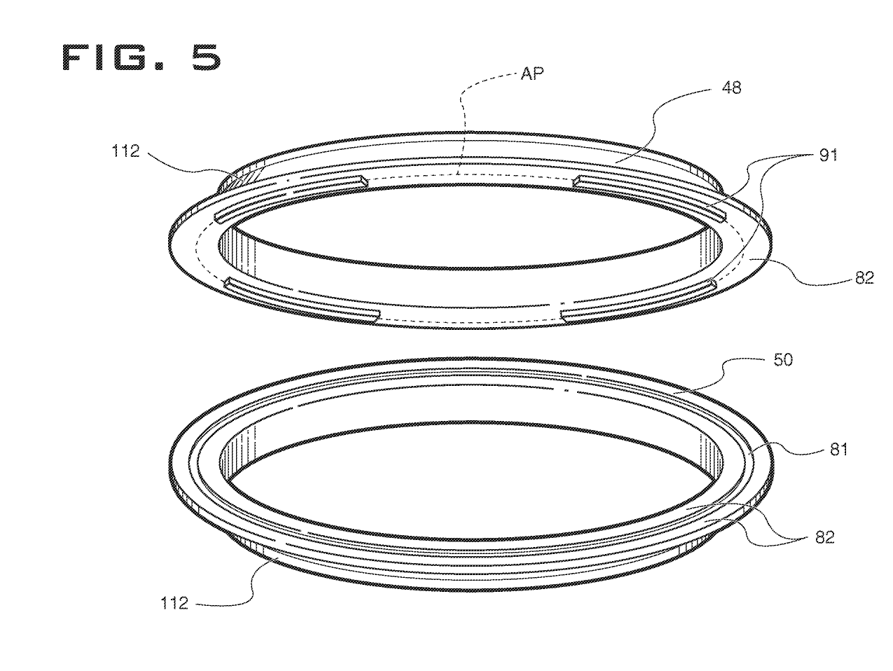

In each of the illustrated embodiments the protrusion 80 of the seal ring stabilization system 110 includes three primary surfaces having cross-sections of substantially equal lengths, namely first and second opposing lateral surfaces 83, 84 and an end surface 85. In cross-section the protrusion 80 may be any one of a variety of geometric shapes; in each of the illustrated embodiments in cross-section, the end surface 85 is substantially perpendicular to the first and second lateral surfaces 83, 84, which are substantially parallel to one another. Options for the protrusion 80 include, by way of example and not by way of limitation, a single, continuous, annular protrusion 90 (FIG. 4) or a plurality of arcuate protrusions 91 (FIG. 5) spaced along an annular path “AP”.

The recess 81 of the seal ring stabilization system 110 is a single, continuous, annular channel or groove; in each of the illustrated embodiments the recess 81 includes three primary surfaces including first and second opposing lateral surfaces 92, 93 and an end surface 94. These surfaces 92, 93, 94 are configured relative to one another such that, when the protrusion 80 is received by the recess 81 and no loads are being sustained by the pin joint assembly 10, a continuous gap 95 exists between the surfaces 83, 84, 85 of the protrusion 80 and the surfaces 92, 93, 94 of the recess 81. The gap 95 includes first and second lateral gap portions 100, 101 and an end gap portion 102. In the illustrated embodiments, the gap portions 100, 101, 102 are substantially equal to one another when the protrusion 80 is received by the recess 81 and no loads are being sustained by the pin joint assembly 10. Thus, the lengths of the lateral surfaces 92, 93 of the recess 81 are greater than the lengths of the corresponding lateral surfaces 83, 84 of the protrusion 80 by a substantially equal lateral difference “LD”, while the length of the end surface 94 of the recess 81 is greater than the length of the end surface 85 of the protrusion 80 by an end difference “ED” approximately equal to twice the lateral difference “LD”. FIG. 3 illustrates this relationship by showing the end difference “ED” as the combination of the two distances that, when taken separately, each equal the lateral difference “LD” and half of the difference “ED” (shown as “½ED”; “½ED”+“½ED”=“ED”). By way of example and not by way of limitation, in one embodiment, the gap portions 100, 101, 102 each substantially equal 0.2 millimeters, the lateral difference “LD” substantially equals 0.2 millimeters, and the end difference “ED” substantially equals 0.4 millimeters.

The first collar 24, the first thrust ring 36, the first sleeve bearing 40, and the first seal 44 comprise a first subassembly 56 of the pin joint assembly 10, while the second collar 26, the second thrust ring 38, the second sleeve bearing 42, and the second seal 46 comprise a second subassembly 58 of the pin joint assembly 10. Depending on the application and environment in which the pin joint assembly 10 is employed, the pin joint assembly 10 may require only one of the subassemblies 56, 58, in which case only one of the end portions of the pin 12 and only the corresponding end portion of the bushing 18 are provided with a subassembly—that is, at least a collar, a thrust ring, a sleeve bearing, and a seal. In such instances, the opposing end portion of the pin 12 and the end portion of the bushing 18 in proximal relation to the opposing end portion of the pin 12, not being provided with all elements of a subassembly, may be provided with no elements of a subassembly or some elements of a subassembly. For instance, by way of example and not by way of limitation, if the first end portion 14 of the pin 12 and the first end portion 20 of the bushing 18 are provided with the first subassembly 56, the second end portion 16 of the pin 12 and the second end portion 22 of the bushing 18 may be provided with only the second sleeve bearing 42 and the second seal 46, thereby omitting the second collar 26 and the second thrust ring 38. As the pin joint assembly 10 is only shown with both the first and second subassemblies 56, 58, this latter example is not shown.

The pin joint assembly 10, including the pin 12, the bushing 28, and the subassemblies 56, 58, may also be provided in a unitary cartridge 60 as shown in FIG. 1 in order to ease maintenance and/or replacement of the pin joint assembly 10. The cartridge 60 is substantially cylindrical but tapers in outer diameter at each end portion 62, 64 of the pin joint assembly 10. Specifically, as shown in FIG. 2, at each of the end portions 62, 64 of the pin joint assembly 10, an outer surface 66 of the bushing 18 cooperates with an outer surface 68, 70 of each of the first and second collars 24, 26, respectively, to define an angle “θ” measuring approximately 3.25 radians (186 degrees). The angle “θ” helps ensure secure installation of the cartridge 60 between the arms “A” and the corresponding plates “P” of the linkage “L” (FIG. 1). The angle “θ” could be smaller or larger than 3.25 radians without detracting from the function of the pin joint assembly 10; by way of example and not by way of limitation, the angle “θ” could measure within an inclusive range of approximately 3.23 to approximately 3.32 radians (approximately 185 to 190 degrees). The tapered outer diameter of the cartridge 60 is provided to enable the cartridge 60 to be installed by swaging, but any alternative structures or features that enable secure installation of the cartridge 60 may be utilized.

### INDUSTRIAL APPLICABILITY

Though the pin joint assembly 10 is illustrated in FIG. 1 within the context of the linkage “L” at the pivot point “PP” defined by the stick “S” and the bucket “B” of the excavator “E”, the pin joint assembly 10 may be employed in order to facilitate articulation of one or more hardware structures within any linkage on any machine.

During use, the pin 12 of the pin joint assembly 10 is held stationary by the first and second collars 24, 26. The bushing 18 rotates about the longitudinal axis “LA” while engaging the pin 12 and the first and second sleeve bearings 40, 42. The first and second sleeve bearings 40, 42, in turn, rotate about the longitudinal axis “LA” while engaging the bushing 18 and the pin 12. The interposition of the first and second sleeve bearings 40, 42 between the bushing 18 and the pin 12 provides two pairs of hardware interfaces, namely a pair of bushing-to-sleeve-bearing interfaces and a pair of sleeve-bearing-to-pin interfaces. As a result, if any particular hardware interface that enables rotation of the bushing 18 loses lubrication, thereby resulting in full or partial seizing of the interface, the remaining, unseized hardware interfaces will help enable the bushing 18 to continue rotating. In this way, the various hardware interfaces provide redundancy to help enable the rotation of the bushing 18 demanded during routine use of the pin joint assembly 10.

During use, the pin joint assembly 10 endures radial loads along or in substantially parallel relation to the transverse axis “TA” (FIG. 2), as well as axial loads along or in substantially parallel relation to the longitudinal axis “LA” (FIG. 2). As discussed above, the sleeve bearings 40, 42 help the pin joint assembly 10 bear radial loads. However, the seal ring stabilization system 110 also helps the pin joint assembly 10 bear radial loads. Specifically, when the seal rings 48, 50 experience radial displacement relative to one another, the protrusion 80 (FIG. 3) displaces within the recess 81 (FIG. 3) until one or more of the surfaces 83, 84, 85 of the protrusion 80 engages one or more of the surfaces 92, 93, 94 of the recess 81. When such engagement occurs or shortly thereafter, the seal rings 48, 50 are substantially prevented from experiencing further radial displacement relative to one another. As a result, gaps between the seal rings 48, 50 and misalignments of the seal rings 48, 50 caused by radial loading of the pin joint assembly 10 are reduced, thereby increasing the life of the pin joint assembly 10 and the seals 44, 46 therein.

The first and second thrust rings 36, 38 help the pin joint assembly 10 bear axial loads. Specifically, during use, the thrust rings 36, 38 slide along the pin 12 and/or compress and decompress in reaction to axial loads, thereby dampening axial loads and, by extension, helping to reduce wear of the pin joint assembly 10 caused by axial loads. The thrust rings 36, 38 reside wholly within the channels 32, 34, respectively, and as a result are better enabled to move as necessary to bring about such dampening. Further, the sleeve bearings 40, 42 extend beyond the bushing 18 into the channels 32, 34, respectively, thereby spacing the thrust rings 36, 38 apart from the bushing 18 in order to help prevent the rotation of the bushing 18 from interfering with the movement and/or compression and decompression of the thrust rings 36, 38 during use of the pin joint assembly 10.

The first and second seals 44, 46 help prevent lubricant (not shown) from leaking out of the channels 32, 34, respectively. Specifically, the first and second seal rings 48, 50 of each of the seals 44, 46 rotate against one another, thereby imparting mechanical pressure against the corresponding gaskets 52, 54. The mechanical pressure from the seal rings 48, 50 compresses the first gasket 52 of each seal 44, 46 against the corresponding collar 24, 26 and compresses the second gasket 54 of each seal 44, 46 against the corresponding end portion 20, 22 of the bushing 18. Accordingly, lubricant (not shown) is restrained from escaping the channels 32, 34 and the subassemblies 56, 58 maintain lubrication for a longer period of time and experience less wear.

A seal ring stabilization system and associated pin joint assembly are disclosed. The specific embodiments disclosed herein are for purposes of illustration only and not for purposes of limitation. Significant changes could be made to the specific embodiments disclosed herein without departing from the scope of the invention, as the scope of the invention is dictated only by the language of the claims.

What is claimed is:

1. A seal ring stabilization system, comprising:
first and second seal rings, each including a substantially planar surface and a substantially non-planar surface opposite the substantially planar surface, the substantially planar surface of the first seal ring and the substantially planar surface of the second seal ring engaging one another;
the first seal ring comprising a protrusion extending from the substantially planar surface of the first seal ring and away from the substantially non-planar surface of the first seal ring;
the second seal ring defining a recess extending from the substantially planar surface of the first seal ring and toward the substantially non-planar surface of the second seal ring;
the recess of the second seal ring receiving the protrusion of the first seal ring.

2. A pin joint assembly, comprising:
a pin having an end portion;
a bushing coaxial with the pin and having an end portion proximal to the end portion of the pin;
a collar engaging the end portion of the pin and having inner and outer portions, the inner portion of the collar being proximal to the end portion of the bushing;
first and second seal rings between the inner portion of the collar and the end portion of the bushing, each seal ring including a substantially planar surface and a substantially non-planar surface opposite the substantially planar surface, the substantially planar surface of the first seal ring and the substantially planar surface of the second seal ring engaging one another;
first and second gaskets engaging the substantially non-planar surfaces of the first and second seal rings, respectively;
the first seal ring comprising a protrusion extending from the substantially planar surface of the first seal ring and away from the substantially non-planar surface of the first seal ring;
the second seal ring defining a recess extending from the substantially planar surface of the first seal ring and toward the substantially non-planar surface of the second seal ring;
the recess of the second seal ring receiving the protrusion of the first seal ring.
